(19) United States
(12) Patent Application Publication
(10) Pub. No.: US 2005/0178066 A1
(43) Pub. Date: Aug. 18, 2005

(54) Door leaf actuator

(76) Inventors: Matthias Drux, Gevelsberg (DE); Holger Hansch, Witten (DE); Thomas Wildforster, Schwelm (DE); Michael Hufen, Wuppertal (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/516,479

(22) PCT Filed: Jan. 9, 2004
(86) PCT No.: PCT/EP04/00088

(30) Foreign Application Priority Data
Jan. 10, 2003 (DE) 103 00 822.5

(51) Int. Cl. E05F 11/24

(52) U.S. Cl. 49/340

(57) ABSTRACT

A door leaf actuator includes a system carrier on which a door closer and other components are arranged. The door closer is arranged in such a way that its drive axle lies as close as possible to one end of the system carrier. In this way, a door leaf drive is provided which is constructed in a simple manner and is easy to service but which nevertheless has only small dimensions.

The invention is directed to a hydraulic door leaf drive with a door closer.

Door leaf drives are sufficiently known and are used, for example, to drive rotating doors. They have a mounting plate on which are mounted the individual components of the door leaf drive, e.g., a power supply, a drive unit, a pump, a door closer, and a switch block. When the door leaf drive is defective or damaged, the entire door leaf drive must generally be dismantled in order to repair or replace the defective component. This is time-consuming and expensive.

Therefore, it is the object of the present invention to overcome the disadvantages mentioned above and to provide a door leaf drive which is constructed in a simple manner and is easy to service but which nevertheless has only small dimensions.

This object is met through the features of claim 1.

According to the invention, the door leaf drive, which has a system carrier on which a door closer and other components are arranged, is constructed in such a way that the drive axle of the door closer lies as close as possible to one end of the system carrier in order to keep the so-called rear axle dimension as small as possible, since the latter affects the total kinematics of the drive.

A pump with a hydraulic block connected to it and a drive motor is attached to the door closer. By means of this arrangement, when the door closer is detached from the system carrier, the pump, hydraulic block and motor are removed at the same time. Therefore, this subassembly can easily be exchanged and also disassembled. Additional hydraulic lines are obviated because the pump is flanged on directly and also because of the hydraulic block, since the connection channels lead through the pump and the hydraulic block directly into the door closer. Further, the quantity of hydraulic fluid can be kept low due to this measure.

A control board is located above the door closer and is fastened to it.

A power supply which is likewise fastened directly to the system carrier in addition to the door closer is placed next to the motor.

A switch block comprising a plurality of switches, e.g., a power supply switch, a program switch or other switches with special functions, is provided on the side of the door closer at the end of the system carrier so as to be acoustically decoupled from the housing. The switches can be covered by a cover panel which can be matched with respect to color.

The above-described construction of the door drive according to the invention is encased by a hood. This hood is fixed, e.g., by pins which engage in recesses on one side and by retaining springs.

As a result of this construction, a door leaf drive is provided in which the individual components can be easily and quickly exchanged. Further, this construction provides a particularly compact door leaf drive that facilitates assembly.

The subclaims contain advantageous further developments of the invention.

Further details, features and advantages of the invention are given in the following description of a preferred embodiment example with reference to the drawings.

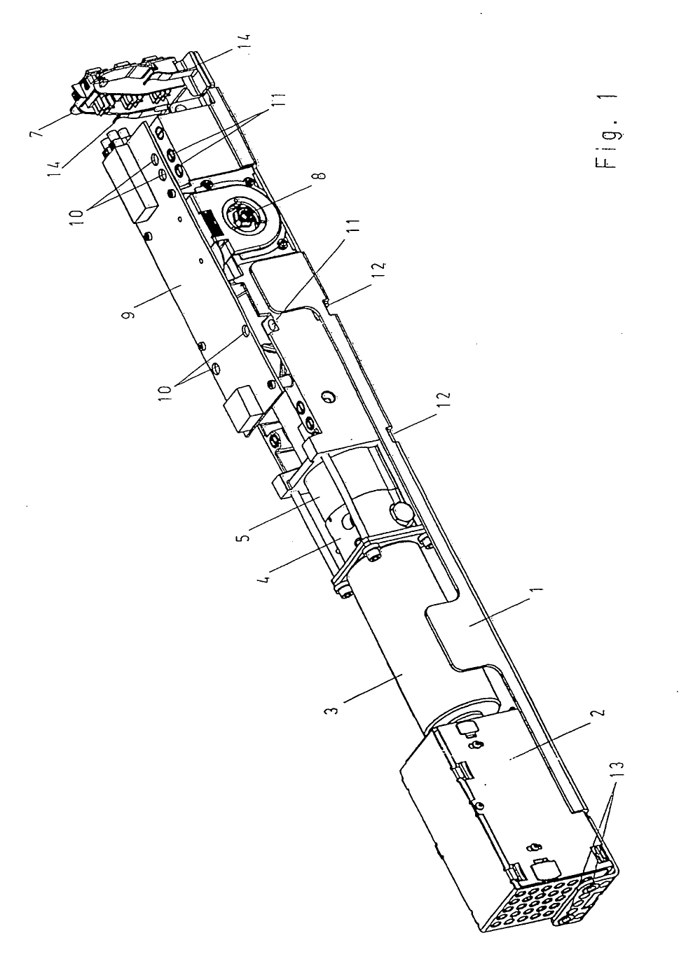

FIG. 1 shows a perspective view of the door leaf drive, according to the invention, from one side;

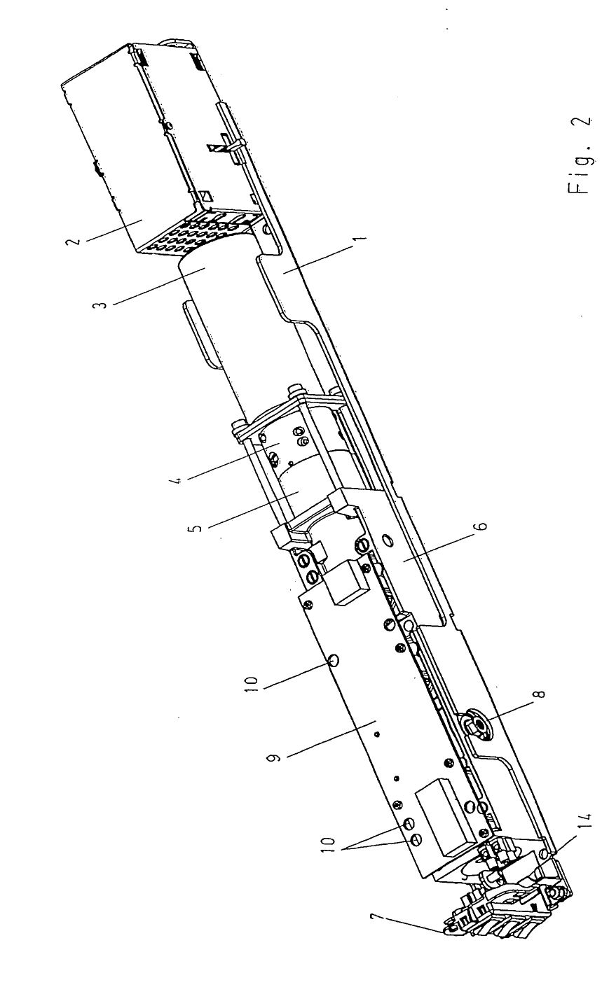

FIG. 2 shows a perspective view of the door leaf drive, according to the invention, from the other side; and

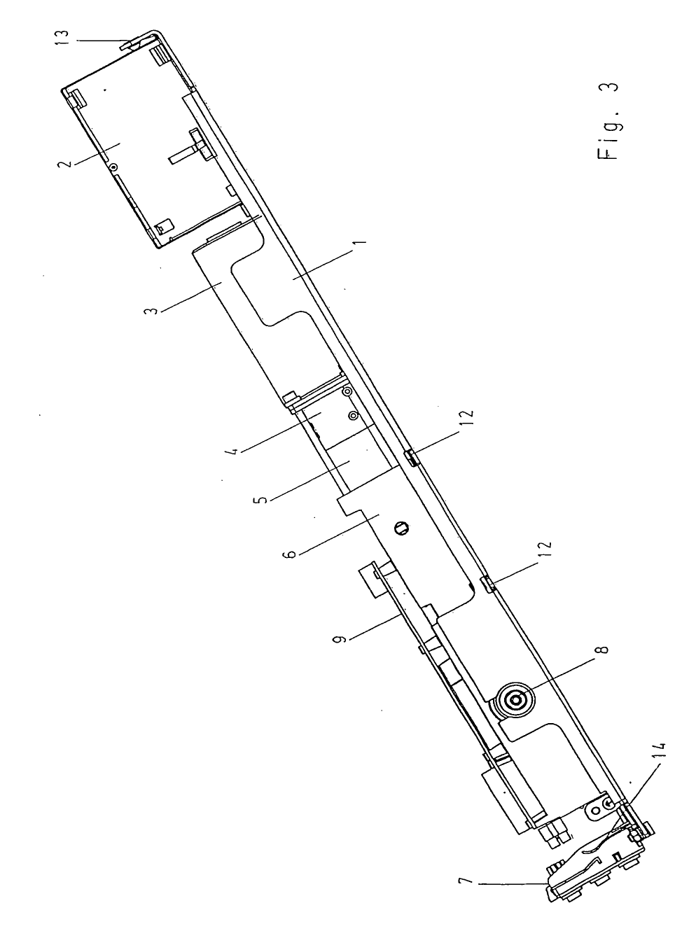

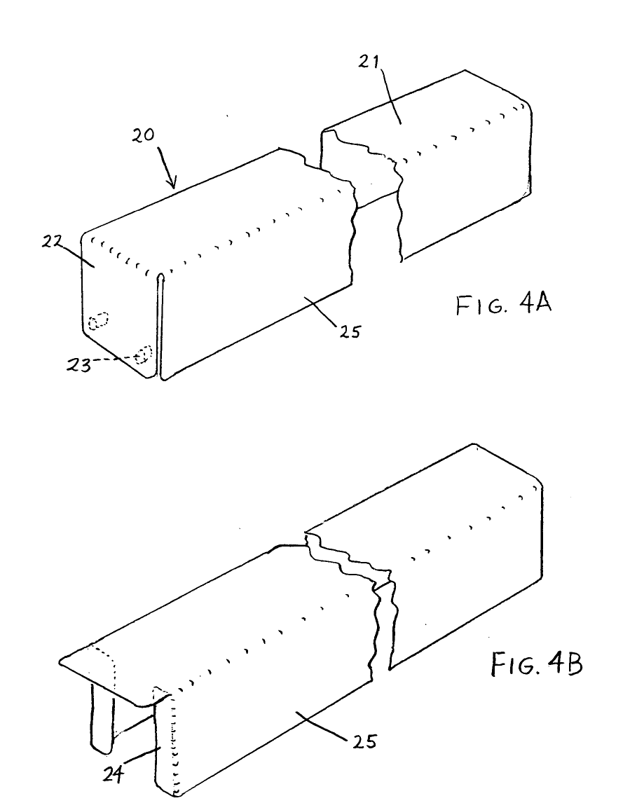

FIG. 3 shows a side view of the door leaf drive according to the invention.

The door leaf drive according to the invention has a system carrier 1 which is fastened to a door, a door frame, or the like, not shown. The individual components of the door leaf drive are arranged on or in the system carrier 1. The system carrier 1 is at least partially U-shaped.

As is shown in FIG. 1, a power supply 2 is located at one end of the system carrier 1. Connected to this power supply 2 are a drive motor 3, a hydraulic block 4 with a pump 5, a door closer 6 and a switch block 7 which is arranged at the end of the system carrier 1 lying opposite from the power supply 2. The door closer 6 is mounted on the system carrier 1 in such a way that its driven axle 8 is arranged as close as possible to one end of the system carrier 1.

Although the hydraulic block 4 lies in front of the pump 5 in FIG. 1, this sequence can be reversed so that the pump 5 lies in front of the hydraulic block 4.

The pump 5 and the hydraulic block 4 are flanged to the door closer 6 only by means of clamping screws 15 proceeding from the drive motor 3. Valves, chokes, connections, etc. are provided in the hydraulic block 4 for controlling the door drive.

A control board 9 that is provided with bore holes 10 through which valves 11 arranged at the door closer 6 are accessible and adjustable is provided above the door closer 6.

According to FIG. 2, the switch block 7 that is provided at one end of the system carrier 1 is constructed as an insulated block with three switches which can serve, e.g., as power supply switch, program switch and venting switch. Naturally, more switches or fewer switches can also be provided.

The system carrier 1 is provided with fastening openings 12 which hold the door drive at the door, door frame or the like by fitting them on to screws that are already mounted and by lateral displacement. The screws are then tightened and the door drive is mounted.

The entire system carrier 1 can be provided with a cover hood, not shown, which covers all components of the door leaf drive with the exception of the switches of the switch block 7. If desired, this cover hood can be provided in different colors allowing it to be integrated within its surroundings or adapted according to individual taste.

The system carrier 1 is provided with locking recesses 13 on one side for supporting the cover hood; locking pins arranged at the cover hood can engage in these locking recesses 13. The locking recesses 13 are arranged on the side of the power supply 2 in the present embodiment example. On the other side (the side of the switch block 7 in the present embodiment example) the system carrier 1 is provided with retaining springs 14 which secure the cover hood.

The preceding description of the invention serves, according to the present invention, for purposes of illustration only and not to limit the invention. Various changes and modifications are possible within the framework of the invention without departing from the scope of the invention and its equivalents.

### REFERENCE NUMBERS

1 system carrier
2 power supply
3 drive motor
4 hydraulic block
5 pump
6 door closer
7 switch block
8 driven axle
9 control board
10 bore holes
11 valves
12 fastening openings
13 locking recesses
14 retaining springs
15 clamping screws

1-11. (canceled)

12. A door leaf actuator comprising:
a system carrier having a first end and a second end;
a plurality of components mounted on the system carrier toward said first end; and
a door closer mounted on the carrier toward said second end, said door closer having a drive axle which is located as close as possible to the second end.

13. The door leaf actuator of claim 12 wherein said components comprise a power supply, a drive motor, a hydraulic block, and a pump.

14. The door leaf actuator of claim 13 further comprising a switch block arranged between the door closer and the second end, said switch block having switches.

15. The door leaf actuator of claim 13 wherein the power supply and the drive motor are arranged in this order from the first end toward the door closer, said hydraulic block and said pump being arranged between the drive motor and the door closer.

16. The door leaf actuator of claim 15 wherein the pump is arranged between the hydraulic block and the door closer.

17. The door leaf actuator of claim 15 wherein said drive motor is provided with a flange, said hydraulic block and said pump being fixed to said door closer by screws extending between said flange and said door closer.

18. The door leaf actuator of claim 12 further comprising a control board fixed to said door closer opposite from said carrier.

19. The door leaf actuator of claim 18 wherein said door closer comprises valves having adjusting screws, said control board having holes for accessing said adjusting screws.

20. The door leaf actuator of claim 12 further comprising a cover hood which can be fixed to said carrier, said cover hood covering said door closer and said components but not covering the switches of the switch block.

21. The door leaf actuator of claim 20 wherein said carrier comprises locking openings at said first end and retaining springs at said second end for fixing said cover hood to said system carrier.

22. The door leaf actuator of claim 21 wherein said cover hood has locking pins which engage in said locking openings.
